(19) United States
(12) Patent Application Publication
(10) Pub. No.: US 2025/0174015 A1
(43) Pub. Date: May 29, 2025

(54) Method and System for Training a Base Model

(71) Applicant: Robert Bosch GmbH, Stuttgart (DE)

(72) Inventors: Stefan Schmid, Waiblingen (DE); Lavdim Halilaj, Leonberg (DE); Cory Henson, Pittsburgh, PA (US); Juergen Luettin, Renningen (DE); Sebastian Monka, Stuttgart (DE)

(21) Appl. No.: 18/943,323

(22) Filed: Nov. 11, 2024

(30) Foreign Application Priority Data
Nov. 28, 2023 (DE) 10 2023 211 845.9

(51) Int. Cl. G06V 10/774; G06T 7/20; G06V 10/26; G06V 20/56

(52) U.S. Cl. CPC G06V 10/774; G06T 7/20; G06V 10/26; G06V 20/56; G06T 2207/20072; G06T 2207/20081; G06T 2207/30241; G06T 2207/30252

(57) ABSTRACT

A method is for training a base model for object detection, trajectory prediction, and/or motion planning of a vehicle. The method includes providing a training data set of image data, with each piece of image data having information about at least one driving scene from a point of view of the vehicle, and providing a knowledge graph including domain-specific knowledge of the at least one driving scene. The method further includes optionally partitioning the image data into a plurality of image sections, and generating information matrices corresponding to the image sections by assigning domain-specific knowledge about the at least one driving scene extracted from the knowledge graph and/or directly from the image data to the plurality of image sections of the image data. The method also includes training the base model based on the information matrices.

This application claims priority under 35 U.S.C. § 119 to patent application no. DE 10 2023 211 845.9, filed on Nov. 28, 2023 in Germany, the disclosure of which is incorporated herein by reference in its entirety.

The disclosure relates to a method for training a base model for object detection and/or trajectory prediction and/or motion planning of a vehicle. The disclosure relates to a system for training a base model for object detection and/or trajectory prediction and/or motion planning of a vehicle. The disclosure relates to a method for object detection and/or trajectory prediction and/or motion planning using such a trained base model. Furthermore, the disclosure relates to a computer program having program code and a computer readable disk.

### BACKGROUND

In today's world, deep neural networks (DNN) have proven to be extremely powerful tools for machine learning, especially in the area of visual embedding. By using textual descriptions, base models are trained to generate a visual representation of objects. However, these models reach their limits when it comes to dealing with scenarios, in which no data and/or samples of the objects are available during training.

To overcome this issue with lack of data, approaches based on classification of object attributes have been developed. These methods attempt to identify attributes such as shape, color, text, etc. to compensate for the missing information. However, these approaches are often based on manually created and inaccurately defined structures that make it difficult to integrate new knowledge and adapt the model to other areas or use cases without starting the entire modeling process from scratch.

The scientific publication [1] “Learning Visual Models using a Knowledge Graph as a Trainer,” discloses a method for training deep neural networks with semantic knowledge graphs/ontologies.

The scientific publication [2] “Radford, A., Kim, J. W., Hallacy, C., Ramesh, A., Goh, G., Agarwal, S., Sastry, G., Askell, A., Mishkin, P., Clark, J., Krueger, G., & Sutskever, I. (n.d.). Learning Transferable Visual Models From Natural Language Supervision” discloses a general method for a base model to learn from text and images.

The scientific publication [3] “Santurkar, S., Dubois, Y., Taori, R., Liang, P., & Hashimoto, T. (2022),” Is a label worth more than a thousand images? A Controlled Study on Representation Learning,” discloses the importance of the descriptive value of captions, especially with regard to small amounts of data.

The scientific publication [4] “LINGO-1: Exploring natural language for autonomous driving. LINGO-1” discloses an open loop travel commentator that combines vision, language and action to improve the way an underlying driving model is perceived and/or interpreted and/or explained and/or trained by a user.

Approaches, such as described in the publication [2], train base models by using descriptive captions. These captions are converted into latent vectors, i.e. word embeddings using language models. Then, the embeddings are used to control the learning process of the base models. Both the text body and the images are crawled from the web. However, in learning scenarios where training data is not present, a test and/or inference data set differs from the training data set. For example, in the test and/or inference data set, there are objects, such as road signs, etc., that were not present in the training data during the training of the base model. However, the authors of the publication [2] clearly pointed out that the approach cannot be adapted to new categories. Thus, new categories cannot be included. In addition, the approach presented in the publication [2] is only limited to specified training patterns and does not integrate human knowledge about a specific domain.

In summary, in the rapidly advancing world of machine learning, learning scenarios present a particular challenge where there is no training data or only a little and/or an insufficient amount of training data present. In such learning scenarios, machine learning models, such as classification and/or segmentation tasks, face the challenge of achieving predictive accuracy, although the objects to be classified and/or segmented either have never been seen before or very few training examples exist. The limited availability of data in these novel situations makes it extremely challenging to make precise predictions through a (trained) classification and/or segmentation model.

To address this issue, it has been shown that using high-level and unambiguous attributes is critical to achieve good performance in such low-data scenarios. By focusing on these meaningful attributes/features, machine learning models may improve their ability to predict and thus achieve improved results even in situations where data availability is limited.

A task that the disclosure is intended to solve is to provide an improved method and/or system for training a base model for object detection and/or trajectory prediction and/or motion planning of a vehicle.

### SUMMARY

The task is solved by a method for training a base model for object detection and/or trajectory prediction and/or motion planning of a vehicle. The task is solved by a system for training a base model for object detection and/or trajectory prediction and/or motion planning of a vehicle.

The disclosure, according to a first aspect, comprises a method for training a base model, in particular for scene understanding, which is indicated as additional input, object detection and/or semantic segmentation and/or trajectory prediction and/or motion planning of a vehicle, with the method comprising the steps of:
providing a training data set of image data, with each piece of data having information about at least one driving scene from a point of view of the vehicle;
providing a knowledge graph comprising domain-specific knowledge of the at least one driving scene;
optionally partitioning the image data into a plurality of image sections;
generating information matrices corresponding to the image sections by assigning domain-specific knowledge about the at least one driving scene extracted from the knowledge graph and/or directly from the image data to the plurality of image sections of the image data;
training the base model based on the information matrices; and
providing the trained base model, in particular for understanding the scene, for object detection and/or trajectory prediction and/or motion planning of the vehicle.

Instead of the step of partitioning the image data into a plurality of image sections, the information matrix may also be derived directly from the image data and/or the knowledge graph.

Object detection and/or semantic segmentation and/or trajectory prediction and/or motion planning of a vehicle is preferably carried out using a separate method, which is improved using the present method. The object detection and/or semantic segmentation and/or trajectory prediction and/or motion planning of a vehicle itself is therefore not necessarily part of the present method, but rather is decoupled from it. In other words, detected objects in the image data, particularly based on existing methods, are either compared to the knowledge graph (see step 2), or in step 4, directly extracted from the image data and used to create the information matrix.

It is understood that the steps according to the disclosure and further optional steps do not necessarily have to be carried out in the order shown, but may also be carried out in a different order. Further intermediate steps may also be provided. The individual steps may also comprise one or more sub-steps without leaving the scope of the method according to the disclosure.

A “knowledge graph” is preferably a structured database that has knowledge and/or information about a wide range of domains or topics. The knowledge graph preferably has domain-specific information. It is preferably a semantic network that presents information in the form of graphs by linking entities (e.g., people, locations, objects, events) to their attributes and relationships. By organizing knowledge in the form of a knowledge graph, it is preferably possible to model and understand complex relationships and/or interdependencies between different entities. The graph allows questions to be asked, relationships to be explored, connections to be analyzed and/or new knowledge to be derived. The knowledge graph is preferably used by AI systems and search engines to provide a more comprehensive and contextual response to user requests. By linking and evaluating information from the knowledge graph, AI systems may develop a deeper understanding of texts, questions, and requests and generate more concise and relevant responses.

“Providing a training data set” preferably means that training image and/or video data is made available from a database and/or from an optical sensor in order to be processed by the base model. Each training image and/or piece of video data has predetermined image attributes related to the object and/or subject included in the respective training image and/or piece of video data and/or the at least one domain. Furthermore, the training image and/or video data may each have at least one class label that is, for example, assigned or otherwise determined by an expert. Extracting image attributes in the present case preferably means that the base model extracts image attributes, for example, on pixel levels, from the provided training data. This step is preferred to identify the relevant features from the images and/or videos used for later information processing.

By means of the present method, object detection and/or semantic segmentation and/or trajectory prediction and/or motion planning of a vehicle may be optimized based on image and/or video data. In this context, in particular at the visual level, semantic attributes are extracted from the image and/or video data and converted into textual image information by incorporation of the knowledge graph, which is provided in the form of the information matrices. The method may also be applied to one-dimensional data (e.g., in production) requiring only neural network-generated embeddings to provide high-level semantic concepts.

In the disclosure, a base model is trained or created that is designed to obtain an understanding of (driving) scenes in the context of autonomous driving. The base model is particularly directed to understanding the spatial-temporal relationships of entities within the domain and their context in driving scenes. The base model also learns how individual driving scenes could develop or potentially develop over time. The base model further preferably learns how to predict and/or supplement individual segments of a driving scene, for example when only insufficient image information is available for visual scene evaluation. The goal of training such a base model is to use an understanding of driving scenes to support the training and improve the performance of various downstream tasks related to autonomous driving, e.g., object detection, semantic segmentation, motion prediction, etc. The base model is preferably trained on the structured information extracted from autonomous driving data sets (e.g., nuScenes) and represented in the form of knowledge graphs. In this way, the base model may preferably learn and/or understand relationships, hierarchies, and/or contextual information about the objects occurring in a driving scene. Training with domain-specific knowledge enables the base model to gain specialized expertise in this area, which allows it to generate more accurate and relevant responses.

The base model in the disclosure, which is used for understanding driving scenes in autonomous driving, preferably allows for supporting and/or optimizing machine learning tasks in the area of autonomous driving, such as object detection, trajectory prediction, motion planning, etc. Similar to learning large language models (LLMs) to understand and/or interpret language from large amounts of written documents, the base model in this disclosure learns to understand and/or interpret and/or predict driving scenes from large amounts of test drives. As LLMs may be used to learn various natural language tasks, such as translation, summary, text analysis, the base model may preferably provide an understanding of driving scenes to support training and/or improve performance of autonomous driving machine learning tasks. The trained base model in the disclosure may either be adjusted and/or trained to specific tasks or serve as a supplementary source for prior knowledge that is already available. For example, the trained base model in the disclosure may be used as model supplementation to a visually operating machine learning model to support, for example, object detection and/or semantic segmentation and/or trajectory prediction and/or motion planning tasks.

The base model is trained on the basis of the knowledge graph for driving scenes. The use of this domain-specific knowledge graph has several advantages. On the one hand, one may take advantage of domain expertise. Domain-specific knowledge graphs preferably provide detailed information about entities, relationships, and/or concepts specific to the domain. This allows the base model to develop a more in-depth understanding of the domain in order to improve the generation of more accurate and/or context-relevant responses. Also, incorporating knowledge graphs enables improved contextual understanding. Domain-specific knowledge graphs allow the base model to better understand the context in which information is presented. This is particularly important for tasks that require a differentiated understanding of domain-specific concepts and terminology. Also, by using knowledge graphs, improved fact checking and/or information gathering for driving scenes may be provided. The base model, which is trained with domain-specific knowledge graphs, is preferably better able to verify facts and/or retrieve accurate information related to the specific domain. This is critical for applications where the accuracy and reliability of the information is paramount. The trained base model in the disclosure also enables an improved handling of domain-specific terminology. In many areas, there is a specific terminology that general machine learning models may not adequately understand. In the disclosure, domain-specific knowledge graph training helps the base model to more easily capture and appropriately use and/or process domain-specific terms. Also, tailored response generation may be provided by the trained base model in the disclosure. More particularly, the base model may generate responses tailored to the domain that provide more relevant and/or accurate information to users. This is particularly important in areas such as autonomous driving where precision is critical. The base model in the disclosure also reduces ambiguity in the interpretation of a driving scene. This is particularly achieved by using the domain-specific knowledge graphs. These help to clearly determine terms and/or concepts within a driving scene that may have multiple meanings in different contexts. This reduces the likelihood of ambiguous or incorrect responses being generated. The trained base model in the disclosure also allows for better integration into existing systems. Specifically, domain-specific base models trained with knowledge graphs may be seamlessly integrated into existing systems and/or workflows within each domain, providing improved functionality and efficiency.

In the disclosure, training of the base model will in particular refer to a method for fine tuning a visual machine learning model in order to adapt it to novel and/or expanded domain knowledge. This improves, for example, detection of traffic signals. In particular, if there is limited access to (training) data, it is important to use unambiguous and meaningful labels and/or labels within a driving scene to train more efficiently, i.e. with less domain-specific data, while still developing a more powerful base model. In particular, the knowledge graph used represents individual driving scenes with agents and/or objects in the respective (driving) scenes, as well as the relationships between the agents and additional information from expanded expertise, e.g. knowledge from geographic map data. The trained base model in the disclosure is able to evaluate what real driving scenes look like and/or how such driving scenes develop (may develop) over time. The base model is trained to determine a spatial-temporal semantic representation of driving scenes. The base model particularly has a suitable deep learning architecture (e.g. transformer architecture) for this purpose.

Without further training or fine tuning, the trained base model is able to make predictions of missing zones or sections within a driving scene or semantic concepts in a future scene in a spatial area of interest (e.g., to predict potentially hidden objects). Furthermore, the base model is able to determine the information matrix or area matrix of a next and/or previous driving scene if the relevant contextual information is available for this purpose, in particular by incorporating the knowledge graph. Furthermore, the trained base model in the disclosure is able to supplement missing contextual information in multiple surface matrices (scene representations).

The information matrix may preferably always be derived from the first-person perspective of a vehicle, wherein the first-person perspective of the vehicle may be positioned within the image sections, over which the information matrices are placed. For example, the information matrix may consist of 11 columns and 20 rows, and the first-person perspective of the vehicle may be positioned, for example, in an image section corresponding to column 6 and row 5.

The knowledge graph preferably has a variety of information and may be further enriched with additional internal and/or external sources of metadata. In particular, in addition to image data, many applications automatically provide graph-based metadata (autonomous driving, production, IoT, etc.). With the method according to the disclosure, this structured metadata may be exploited in the form of attributes, and in particular as a high-level description of the respective objects. By applying a knowledge graph to a particular area, the attributes of the objects included in the image and/or video data, regardless of whether they were previously included in image and/or video data, may be extracted and used for similarity comparisons in the embedding vector space with the objects modeled in the knowledge graph. This opens up new opportunities to expand and adapt the model without the need for a full restart. In particular, the combination of deep neural networks and knowledge graphs shows a promising direction for improving the performance of models in low-data scenarios. Inclusion of prior knowledge based on information from a knowledge graph not only improves solution generation in this way, but also increases a model's ability to successfully generalize and/or classify and/or segment in new and/or unexplored environments.

The present approach relates to the conceptualization and/or integration of domain knowledge about semantic axioms. This human-created knowledge may be integrated and adapted to the changes that occur in each domain. Furthermore, the coding of knowledge in the form of a knowledge graph or allows for flexible representation and may be converted into a vector space by means of embedding methods. This vector space is used to determine the similarity to the attributes extracted from the visual space.

The disclosure further relates to an adjustment of a polynomial reduction algorithm to exploit word size shifts that are adjusted to the word size of the computer hardware based on such technical considerations and may help to create the technical effect of efficient hardware implementation of the algorithm.

The disclosure may be used for analysis of (image and/or video) data obtained from a sensor. In the disclosure, the term “image and/or video data” may also be replaced with “sensor data”. The sensor may determine measurements of the environment in the form of sensor signals, which may be composed of the following elements, digital images, e.g. video, radar, lidar, ultrasound, movement, thermal images, audio signals, and/or specific data, such as 1D-Daten (e.g., in production). In principle, it is also possible to obtain information based on a sensor signal about elements that are encoded by the sensor signal. In other words, an indirect measurement may be made based on a sensor signal used as the direct measurement. This is also understood as virtual sensor technology. Furthermore, the present method may be used to classify and/or categorize and/or segment the sensor data, in particular to detect the presence or absence of objects in the sensor data and/or to perform semantic segmentation of the sensor data, e.g. with respect to traffic signs and/or road surfaces and/or pedestrians and/or vehicles and/or other things. The present method may also be used to determine a continuous value or multiple continuous values, i.e. to perform a regression analysis, e.g., regarding a distance and/or a speed and/or an acceleration and/or tracking of an element, e.g. an object, in the data. The present method may be used to detect abnormalities in a technical system. For example, Gauss deviations and/or other uncertainty values may be used to detect abnormalities. The present method may be used to control and/or support a technical system, such as a computerized machine, e.g., a robotic system, a vehicle, a household device, a power tool, a manufacturing machine, a personal assistant, or an access control system. The present method may be employed in a system for transmitting information, such as a monitoring system or a medical (imaging) system. The present method may be employed for measuring and/or controlling in such a system. The present method may be used to analyze data (e.g., scalar time series), particularly from a sensor, i.e., a perception system. The present method may be used to subsequently operate and/or support an operation of the technical system.

For example, it must be ensured that an automated vehicle does not hit pedestrians. Based on the semantic segmentation, in particular, a computer calculates depth information about all pedestrians present in an image space, and further calculates a trajectory around those pedestrians, and controls the autonomously driving vehicle to follow this trajectory so closely that it does not encounter any pedestrians. This also applies in principle to any mobile robot in order to avoid such people who might be in its path of travel and/or outside of its path of motion. The method according to the disclosure may be used effectively for this purpose.

Furthermore, the method according to the disclosure may be used in combination with a regression algorithm to determine, in particular, an exact spatial orientation of the vehicle using data from yaw rate and/or linear acceleration sensors of a vehicle.

In the disclosure also particularly preferably describes a control unit that is comprised in an autonomous vehicle and/or a robotic system and/or an industrial machine, on which the present method is at least partially executable.

With the particularly actively learning method according to the disclosure, a trained base model may be provided that may learn to determine at which operating point of an engine an exhaust emission of the engine is to be tested. The engine is preferably operated at this operating point, and exhaust emissions are measured and input into the actively learning attribute learning model as input data until the model is deemed good enough.

In an automated vehicle, the base model described herein, which is particularly actively learning, preferably defines predetermined scenarios for which image and/or video data and/or data is to be collected from alternative sensors.

In a networked physical system, e.g., a networked automated vehicle, an anomaly detector may also be used to detect whether a selected frame of predefined length (e.g., 5s) from an accelerometer time series has an anomaly. If this is the case, this frame is transmitted to a back-end computer, where it may be used, for example, to define corner cases for the testing of the ML system, according to the result of which the connected physical system is operated.

In a preferred embodiment, based on the information matrices, the base model is trained to determine spatial-temporal relationships of entities within a driving scene and/or a context of the entities within the driving scene and/or a time progression of the driving scene or across the driving scene. As a result, even future driving scenes may be better predicted with support from the base model. In training or during inference, the last n driving scenes are preferably considered to thereby learn or predict the temporal relationship.

In a preferred embodiment, the domain-specific knowledge of the at least one driving scene contained in the knowledge graph comprises structured information about the at least one driving scene obtained from autonomous driving data sets, in particular nuScenes datasets, wherein the structured information includes relationships and/or hierarchies and/or contextual information about objects occurring in a particular driving scene. The “nuScenes” data sets are a collection of extensive multimodal data sets specifically designed for autonomous driving research and development. nuScenes contains data captured using a variety of sensors such as cameras, lidar, radar, and others. These sensors capture a 360-degree view of the environment. The data was collected in different urban environments including complicated traffic scenarios, different weather conditions and times of day. An essential feature of the nuScenes data sets is the detailed annotation. Objects in the scenes, such as vehicles, pedestrians, and obstacles, are marked and categorized, facilitating the development and testing of algorithms for the perception and behavior of autonomous vehicles. Researchers and developers in machine vision and autonomous driving use these data sets to train and test algorithms for object detection, trajectory prediction, scene analysis, and other machine learning-based tasks. nuScenes is widely accessible to the research community, facilitating collaboration and comparison of different approaches in the area of autonomous driving.

In a preferred embodiment, the training data set of image data is generated by test drives with the vehicle and/or by historical travel data with the vehicle. The training data may also be extracted from existing databases. The training data may also be supplemented with further traffic data, for example, drone captures and/or high-resolution satellite captures of traffic scenes, particularly of traffic hubs and/or at intersections and/or traffic lights.

In a preferred embodiment, the base model comprises a machine learning model, particularly an autoregression based transformer model or a masking based transformer model. An autoregression based transformer model is a type of model used in the processing of natural language (NLP). It is based on mechanisms of self-attention and cross-attention that allow it to understand relationships between words in one sentence or between sentences, regardless of their position. Autoregressive means that the transformer model operates sequentially, with each prediction based on the predictions made so far. For example, an autoregressive transformer model predicts each next word when generating text based on the words already generated. A masking model describes a model in which portions of the input data are intentionally “masked” or hidden. The masking model is then trained to reconstruct or predict the masked portions. For example, in the processing of natural language, certain words are masked in a sentence. The model must then use the context of the surrounding words to correctly guess or generate the masked words. One known example of a masking model in NLP is BERT (Bidirectional Encoder Representations from Transformers). BERT trains its predictive skills by randomly masking words in a text and trying to guess them based only on their context.

In other words, the training of the base model may be done either with a particular (transformer-based) deep learning architecture that may begin with randomly initialized weights, or by fine tuning an existing base model (e.g., T5, Roberta, Llama). For very large base models (e.g., Llama), fine tuning may also be limited to a few layers of the network, for example using an adapter or LoRA approach.

The base model in the disclosure is trained with a deep neural network (DNN) to provide an embedding space based on a large information corpus, e.g. text, images or sound. The base model in the disclosure is tailored to specific areas, such as autonomous driving, where spatial and temporal dimensions as well as interactions between traffic participants are critical for predictive tasks. By incorporating the knowledge graph following an underlying ontology, high-level information between agents and their positions may be encoded with respect to location and time. This information is used to train the more efficient and effective base model for autonomous driving scene understanding tasks.

In a preferred embodiment, if the base model comprises a masking-based transformer model, one or more information entries of the information matrices are masked and/or hidden randomly or in a predetermined manner to train the base model to predict and/or determine the masked and/or hidden information entries. To optimize the base model, the masking may also be targeted to entities of particular interest or low performance. Moreover, the masking may also be limited to spatial areas within the image data that are of particular interest from the vehicle's point of view (e.g., directly in front of the vehicle).

It should be mentioned that the training may be done for a whole “next driving scene”. Thus, preferably not only individual matrix fields are masked. Rather, the model learns to predict an entire next driving scene based on the previous driving scenes.

In a preferred embodiment, the base model comprises a pre-trained large language model (LLM). In other words, the base model is fine tuned from an already pre-trained large language model (LLM). For example, the base model may comprise a language model that is already pre-trained and that is only trained on domain-specific knowledge or in the domain context. This allows the training to be designed more efficiently.

In a preferred embodiment, the number of rows and columns of the information matrices corresponds to the number of the image sections, wherein each cell of the information matrices has domain-specific knowledge in the form of semantic concepts of the entities or events present in the spatial dimensions of the image sections, wherein the domain-specific knowledge includes information about road infrastructure facilities and/or pedestrians, and/or traffic signs and/or stop areas and/or construction site markings and/or pedestrian crossings and/or potential vehicle trajectories/paths and/or vehicles, annotated with actions and/or context-relevant information, such as, in particular, a path traveled since a previous driving scene and/or a traffic participant's orientation difference between the driving scene and the previous driving scene and/or a country and/or an intended route and/or direction.

In one embodiment, more than two information matrices are utilized when training to learn temporal behavior across individual driving scenes (“snapshots”). Preferably, the driving scenes are viewed at 2 Hz. In addition to the more than two information matrices, the information may be provided as to which route the vehicle has traveled between the scenes or which steering angle the vehicle has taken. Additionally, still additional metadata, such as a country in which the vehicle is traveling, and/or a route and/or direction of travel of the vehicle may be provided.

The determination of the information matrices is based in particular on a driving scene representation in the form of a structured knowledge graph, which in particular forms a generic Scene Knowledge Graph (SKG). Based on this, the relevant information of individual driving scenes, in particular from the point of view of a particular traffic participant, is extracted in the form of partial graph or subgraph. In particular, a “knowledge graph embedding model” may be used. A knowledge graph embedding model is a model that converts information from a knowledge graph into a numeric vector space. A knowledge graph is preferably a structure that represents knowledge data in the form of entities (objects) and their relationships. Each entity is preferably represented by a unique node in the graph, and relationships between the entities are represented by edges. The goal of a knowledge graph embedding model is to encode the semantic meaning of entities and relationships in a knowledge graph in, particularly latent, vectors, such that mathematical operations such as similarity comparisons and/or clustering may be performed on the embeddings. By embedding in a vector space, the abstract relationships between the entities are represented in a compact and predictable form that may be more easily processed by other machine learning models. There are different approaches to knowledge graph embedding models such as TransE, TransR, DistMult, ComplEx, etc.

This partial graphs or subgraphs are preferably transformed into a two-dimensional spatial area matrix, i.e. the respective driving scene-specific information matrix. The representation is preferably from the point of view of the vehicle using the base model. The information matrix preferably has predefined dimensions (number of rows and columns) and is composed of a plurality of predefined zones (size of the sub-areas). The information matrix is preferably constructed from the perspective of the traffic participant, i.e., comprises his spatial-temporal orientation in the respective spatial context. Each zone of the information matrix is preferably associated with the semantic concepts in particular in the form of natural language or textual information, the scene elements and/or events present in the spatial dimensions of the zone, such as road infrastructure equipment, pedestrians, traffic signs, stop areas, pedestrian crossings, potential vehicle trajectories/paths (e.g., right turners), vehicles, annotated with their actions (car stops, car parks, car accelerates), etc. A header of the information matrix preferably includes additional contextually-relevant information including, but not limited to, the travel path since the previous scene, the participant's difference in orientation between the current and the previous scene, the country, the intended route/direction, etc.

Next, the base model, based on deep learning architecture, is trained on the latent vector representation of the respective information matrix in a self-monitored manner. This is preferably done by concatenating the information matrix (incl. header information) of a current and a predetermined number of previous driving scenes from the vehicle's point of view and then transferring these concatenated information matrices to the base model. The deep learning architecture preferably initially generates tokens for each of the data elements (the header) and semantic concepts (in the respective information matrix) and concatenates them with specific tokens to indicate the context information (e.g., distance, orientation difference, etc.) as well as the position coding (e.g., columns, rows, etc.). The base model, when a masking model, preferably begins with learning the information matrices and their progression in light of the contextual information by randomly hiding one or more zones (or one or more semantic concepts) and/or header information (context). Since the base model knows a correct answer based on the training data, it may calculate the loss and track it back to adjust the weights of the base model. In this way, the base model learns to focus on the relevant aspects of the training data through attention mechanisms.

It is understood that individual previous driving scenes may be skipped (e.g., only every 2nd, 3rd, etc. scene). Alternatively, the same driving scene may be provided multiple times with one driving path=0) for data enrichment purposes.

In a preferred embodiment, the at least one image and/or piece of video data is captured by at least one optical sensor, particularly a camera and/or a lidar sensor and/or a radar sensor and/or an ultrasonic sensor. In principle, other sensors and/or sensor data are also conceivable as long as they are processable from the attribute learning model and/or the knowledge graph embedding model and/or are transferable to semantic embedding.

In a preferred embodiment, the at least one image and/or piece of video data is generated by data augmentation from existing image and/or video data. Data augmentation refers to a machine learning technique, in which new data points are artificially generated by transforming and/or modifying existing data. The goal of data augmentation is to increase the scope and diversity of available training data to improve the performance and robustness of machine learning models. Data augmentation may employ different transformations depending on the nature of the data and the requirements of the model. In the field of image processing, operations such as trimming, scaling, rotating, mirroring, or adding noise may be particularly applicable to generate new images that are slightly different from the original data.

According to a second aspect, a system is proposed for training a base model, in particular for scene understanding, which is indicated as additional input, object detection, and/or semantic segmentation and/or trajectory prediction and/or motion planning of a vehicle. The system comprises an evaluation and/or computing device that is configured to perform at least the following steps:
providing a training data set of image data, with each piece of data having information about at least one driving scene from a point of view of the vehicle;
providing a knowledge graph comprising domain-specific knowledge of the at least one driving scene;
optionally partitioning the image data into a plurality of image sections;
generating information matrices corresponding to the image sections by assigning domain-specific knowledge about the at least one driving scene extracted from the knowledge graph and/or directly from the image data to the plurality of image sections of the image data;
training the base model based on the information matrices; and
providing the trained base model, in particular for a scene understanding, for object detection and/or trajectory prediction and/or motion planning of the vehicle.

Instead of the step of partitioning the image data into a plurality of image sections, the information matrix may also be derived directly from the image data and/or the knowledge graph.

The statements made for the method according to the first aspect apply accordingly, taking into account language modifications for the system according to the disclosure. All embodiments and/or features and/or feature descriptions described in connection with the method apply in the same way to the system and/or the evaluation and/or control device.

In another aspect, a method is provided for object detection and/or semantic segmentation and/or trajectory prediction and/or motion planning of a vehicle utilizing such a trained base model.

According to another aspect, an evaluation and/or control device of an imaging sensor is proposed that is configured to perform the method for object detection and/or semantic segmentation and/or trajectory prediction and/or motion planning of a vehicle. This means that the evaluation and/or control device represents a device that is preferably used in connection with an imaging sensor. The evaluation and/or control device may comprise, for example, a camera control unit (CCU) or be comprised in such a CCU. An imaging sensor is preferably a sensor that is used to capture visual information and to convert it into electronic data, for example, in digital image processing or medical imaging. Alternatively, an audio sensor may also be used when the data to be classified and/or segmented comprises, for example, audio data.

According to the disclosure, a computer program with program code is also described to perform at least portions of the method according to the first aspect or the third aspect, each in one of its embodiments, when the computer program is executed on a computer. In other words, the computer program (product) according to the disclosure comprises commands that, when the program is executed by a computer, cause the computer to perform the steps of the method according to the disclosure in one of its embodiments.

According to the disclosure, a computer-readable data carrier with program code of a computer program is also proposed to perform at least portions of the method according to the first aspect or the third aspect, each in one of its embodiments, when the computer program is executed on a computer. In other words, the disclosure concerns a computer-readable (memory) medium comprising commands that, when the program is executed by a computer, cause the computer to perform the steps of the method according to the disclosure in one of its embodiments.

The described embodiments and further developments may be combined with one another as desired.

Further possible configurations, developments and implementations of the disclosure also comprise not explicitly mentioned combinations of features of the disclosure described above or below with respect to exemplary embodiments.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the mentioned advantages become apparent from the drawings. The illustrated elements of the drawings are not necessarily shown to scale with respect to one another.

The figures show:

FIG. 1 a schematic flow chart of an exemplary embodiment of the present method for classifying an image and/or a piece of video data;

FIG. 2A a schematic block diagram of an exemplary embodiment of the present method;

FIG. 2B a schematic block diagram of an exemplary embodiment of the present method, shown divided into training phases and an inference phase; and

FIG. 2C another schematic block diagram of an exemplary embodiment of the present method, shown divided into training phases and an inference phase.

### DETAILED DESCRIPTION

In the figures of the drawings, identical reference numbers denote identical or functionally identical elements, parts or components, unless stated otherwise.

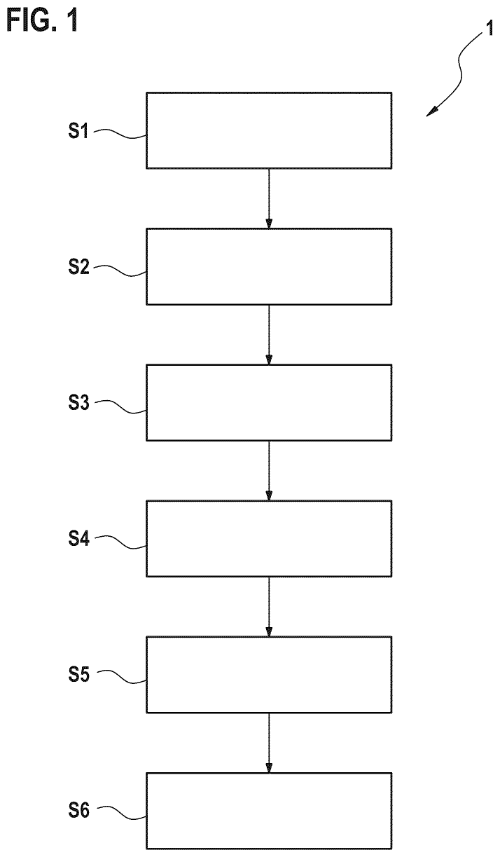

FIG. 1 shows a schematic flow chart of a method for classifying at least one image and/or piece of video data.

In any embodiment, the method may be performed at least in part by a system 1, which may comprise a plurality of components not shown here, for example one or more supply devices and/or at least one evaluation and calculation device. It is understood that the supply device may be configured together with the evaluation and computing device or may be different from it. Furthermore, the system may comprise a storage device and/or an output device and/or a display device and/or an input device.

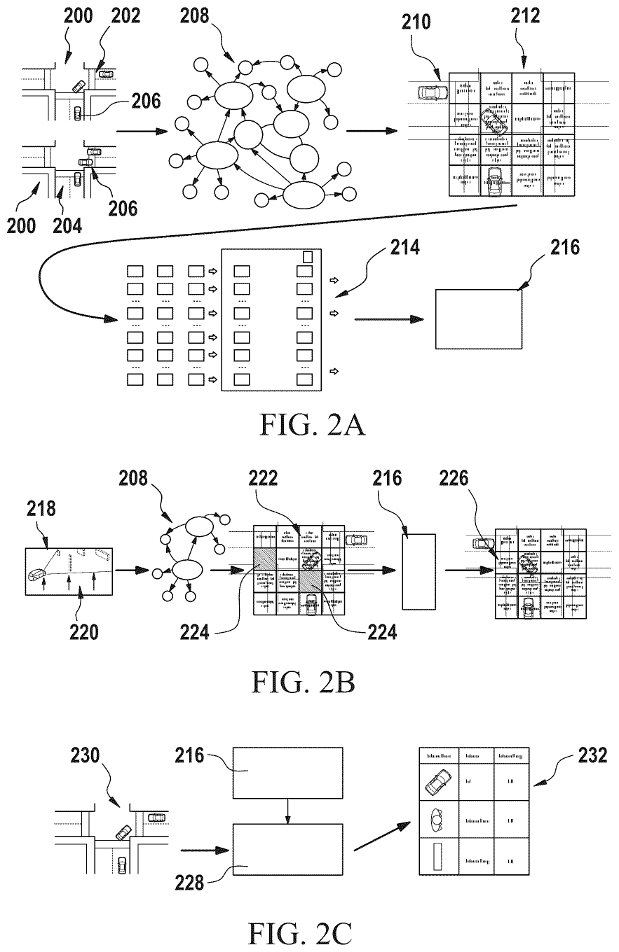

The computer-implemented method comprises, referring to FIG. 2A, at least the steps of:

In a step S1, providing a training data set of image data 200, with each piece of data having information about at least one driving scene 202, 204 from a point of view of a vehicle 206.

In a step S2, providing a knowledge graph 208 comprising domain-specific knowledge of the at least one driving scene 202, 204

in a step S3, optionally partitioning the image data 200 into a plurality of image sections 210. Step S3 is to be understood is being purely optional. Instead of the step S3 of partitioning the image data into a plurality of image sections 210, the information matrix 212 may also be derived directly from the image data 200 and/or the knowledge graph 208.

In a step S4, generating information matrices 212 corresponding to the image sections 210 by assigning domain-specific knowledge about the at least one driving scene 202, 204 extracted from the knowledge graph 208 to the plurality of image sections 210 of the image data 200.

In a step S5, a base model 214 is trained based on the information matrices 212.

In a step S6, the trained base model 216 is provided for object detection and/or trajectory prediction and/or motion planning of the vehicle.

FIG. 2B shows the trained base model 216 that was trained to understand the driving scenes 202, 204. The trained base model 216 is a masking model. As an input, the trained base model 216 receives captured image data 218 of a driving scene 220, particularly from an imaging sensor. A partial graph adjusted to the driving scenes 220 is preferably extracted from the knowledge graph 208, from which the information matrix 222 is generated for the driving scene 220. For example, a portion of the information matrix 222 is unfilled, because there was an information shortage in these sections 224 of the image data 218. By means of the masking model, the information in these unfilled sections 224 may be predicted. The information matrix 222 may be thereby completed as indicated by reference number 226. This improves accuracy in predicting and/or object detection and/or semantic segmentation of the image scene 220.

FIG. 2C shows the trained base model 216 during inference, that is, during the object detection application. A visually operating object detection model 228 is expanded by the base model 216 trained based on language to improve model performance in object detection within a driving scene 230. It may be seen from table 232 that the objects (Car, Pedestrian, PedCrossing) comprised in driving scene 230 are each highly likely to be determined (probability). Accuracy is improved with the base model trained according to the disclosure.

What is claimed is:

1. A method for training a base model for object detection, semantic segmentation, trajectory prediction, and/or motion planning of a vehicle, the method comprising:
providing (S1) a training data set of image data, each piece of training data having information about at least one driving scene from a point of view of the vehicle;
providing (S2) a knowledge graph comprising domain-specific knowledge of the at least one driving scene;
optionally partitioning (S3) the image data into a plurality of image sections;
generating (S4) information matrices corresponding to the image sections by assigning domain-specific knowledge about the at least one driving scene extracted from the knowledge graph and/or directly from the image data to the plurality of image sections of the image data;
training (S5) the base model based on the information matrices; and
providing (S6) the trained base model for scene understanding, object detection, trajectory prediction, and/or motion planning of the vehicle.

2. The method according to claim 1, wherein the base model is trained based on the information matrices to determine spatial-temporal relationships of entities within the at least one driving scene, a context of the entities within the driving scene, and/or a time progression of the driving scene.

3. The method according to claim 1, wherein:
the domain-specific knowledge of the at least one driving scene contained in the knowledge graph comprises structured information about the at least one driving scene obtained from autonomous driving data sets, and
the structured information includes relationships, hierarchies, and/or contextual information, about objects occurring in the at least one driving scene.

4. The method according to claim 1, wherein the training data set of image data is generated by test drives with the vehicle and/or by historical travel data with the vehicle.

5. The method according to claim 1, wherein the base model comprises a machine learning model including an autoregression based transformer model or a masking based transformer model.

6. The method according to claim 5, wherein when the base model comprises a masking-based transformer model, one or more information entries of the information matrices are masked and/or hidden randomly or in a predetermined manner to train the base model to predict and/or determine the masked and/or hidden information entries.

7. The method according to claim 1, wherein the base model comprises a pre-trained large language model.

8. The method according to claim 2, wherein:
a number of rows and columns of the information matrices corresponds to a number of the image sections,
each cell of the information matrices has domain-specific knowledge including semantic concepts of the entities or events present in spatial dimensions of the image sections, and
the domain-specific knowledge includes information about road infrastructure facilities and/or pedestrians, and/or traffic signs and/or stop areas and/or construction site markings and/or pedestrian crossings and/or potential vehicle trajectories/paths and/or vehicles, annotated with actions and/or context-relevant information including a path traveled since a previous driving scene and/or a traffic participant's orientation difference between the driving scene and the previous driving scene and/or a country and/or an intended route and/or direction.

9. The method according to claim 1, wherein the image data is acquired from at least one optical sensor or generated by data augmentation from existing image and/or video data.

10. The method according to claim 1, wherein a computer program comprises program code configured to execute at least portions of the method when the computer program is executed on a computer.

11. A non-transitory computer-readable data carrier comprising program code of a computer program configured to execute at least portions of the method according to claim 1 when the computer program is executed on a computer.

12. A method for object detection, semantic segmentation, trajectory prediction, and/or motion planning of a vehicle utilizing a trained base model according to claim 1.

13. An evaluation and/or control device of an imaging sensor configured to perform a method according to claim 12.

14. A system for training a base model for object detection, semantic segmentation, trajectory prediction, and/or motion planning of a vehicle, the system comprising:
an evaluation and/or computational device configured to:
provide a training data set of image data with each piece of data having information about at least one driving scene from a view of the vehicle;
provide a knowledge graph comprising domain-specific knowledge of the at least one driving scene;
optionally partition the image data into a plurality of image sections;
generate information matrices corresponding to the image sections by assigning domain-specific knowledge about the at least one driving scene extracted from the knowledge graph and/or directly from the image data to the plurality of image sections of the image data;
train the base model based on the information matrices; and
provide the trained base model for scene understanding, for object detection, trajectory prediction, and/or motion planning of the vehicle.
